(19) United States
(12) Patent Application Publication
(10) Pub. No.: US 2025/0011090 A1
(43) Pub. Date: Jan. 9, 2025

(54) CARRIER

(71) Applicant: EVOSTORE B.V., HEIST-OP-DEN-BERG (BE)

(72) Inventors: Daniël Alfons Augusta SPITS, HEIST-OP-DEN-BERG (BE); Sylwester KOPASZEWSKI, HEIST-OP-DEN-BERG (BE)

(21) Appl. No.: 18/710,124

(22) PCT Filed: Nov. 16, 2022
(86) PCT No.: PCT/IB2022/061026

§ 371 Date: May 14, 2024

(30) Foreign Application Priority Data
Nov. 16, 2021 (BE) 2021/5884
Nov. 16, 2021 (BE) 2021/5885

(51) Int. Cl. B65G 1/137; B65G 1/04

(52) U.S. Cl. CPC B65G 1/1375; B65G 1/0414; B65G 1/0435; B65G 1/0464

(57) ABSTRACT

Assembly for automating a rack with rows and columns, wherein the assembly has a lying rail which extends over a plurality of columns, wherein the assembly further comprises a carriage which is compatible with the lying rail so as to be movable along the plurality of columns, wherein the system further comprises a carrier which is connected movably to the carriage for up and downward movement along a plurality of rows, wherein the assembly further has a plurality of upward guides for guiding the carrier during the up and downward movement, wherein the plurality of upward guides are provided to be fixedly connected to the rack, wherein the carrier has a guide block which is compatible with the upward guides in a manner such that a first horizontal movement of the carrier in line with the rack and a second horizontal movement of the earner transversely of the rack is substantially prevented while an upward and downward movement of the earner is allowed.

The invention relates to an assembly for automating a rack with rows and columns. The invention further relates to a method for automating a rack with rows and columns.

In an industrial environment a rack with rows and columns is also often referred to as a storage unit. When such a rack is provided with a system for at least partial automated loading and unloading of the rack, an automated storage unit is referred to. In the logistics sector automated storage units are mainly used where so-called pick and place units remove goods from the rack and store them in the rack on the basis of instructions. Such systems are known and are typically very complex and expensive.

It is an object of the invention to provide an assembly for automating a rack with rows and columns in a manner which is simpler and cheaper.

The invention provides for this purpose an assembly for automating a rack with rows and columns, wherein the assembly has a lying rail which extends over a plurality of columns, wherein the assembly further comprises a carriage which is compatible with the lying rail so as to be movable along the plurality of columns, wherein the system further comprises a carrier which is connected movably to the carriage for up and downward movement along a plurality of rows, wherein the assembly further has a plurality of upward guides for guiding the carrier during the up and downward movement, wherein the plurality of upward guides are provided to be fixedly connected to the rack, wherein the carrier has a guide block which is compatible with the upward guides in a manner such that a first horizontal movement of the carrier in line with the rack and a second horizontal movement of the carrier transversely of the rack is substantially prevented while an upward and downward movement of the carrier is allowed.

A stand-alone pick and place unit is expensive because stability during moving of goods into and out of the rack and during horizontal displacement of the unit is difficult to guarantee. A stand-alone pick and place unit is traditionally supported by a rail at ground level, over which the pick and place unit travels. It is particularly when a heavy object is taken from the rack that the pick and place unit will have a tendency to tilt sideways, and reinforcements must be arranged for this purpose. A further guide rail, whereby the lateral vertical stability transversely of the longitudinal movement is achieved, is for this purpose typically provided on the upper side. Since such a pick and place unit has vertically at least the height of the rack, precautions must likewise be taken so that the tendency to tilt is compensated for during acceleration and deceleration of the high unit with loads. Multiple expensive modifications must be made in order to ensure the safety of a stand-alone pick and place unit.

The rack is constructed from a plurality of rows and a plurality of columns. The rack thereby provides a substantially two-dimensional grid, wherein goods are placeable in each compartment of the grid. The carrier is typically situated adjacent the of the rack, i.e. in a space lying adjacently of the two-dimensional grid, wherein the carrier is able to position itself at each compartment in the grid by a combination of horizontal and vertical displacements. The upward guides are connected fixedly to the rack, typically at the position of the space where the carrier is situated.

The invention is based on the insight that when a pick and place unit is integrated with a rack, more specifically with a carrier compatible with guides suspended from the rack, many of the drawbacks stated above in the context of a stand-alone pick and place unit will be obviated without any major additional modifications. This makes the assembly according to the invention considerably cheaper and simpler than existing pick and place units. According to the invention, the rack is provided with an upward guide for fixing a horizontal position of the carrier, this being when the carrier engages on the upward guide. The carrier is provided to move goods into and out of the rack, wherein the carrier will transport the goods between a first and a second position. When goods are moved into and/or out of the rack, the carrier is on one side connected to the upward guide and on the other connected to the carriage. The carriage is provided to determine in each case the vertical position of the carrier. When the carrier does not engage in the vertical guide, the carriage can also displace the carrier in the horizontal direction. This provides advantages in respect of stability, and thereby also advantages in respect of safety.

The carrier is preferably suspended under the carriage. When moving up and downward the carrier is guided by an upward guide. More specifically, the carrier has an engaged state, wherein the carrier is connected to the rack via the upward guide and the horizontal position of the carrier is thereby maintained. The carrier further has a non-engaged state, or free state, wherein the carrier is not connected to the rack via the upward guide, so that the carrier can be displaced horizontally by the carriage. The free state can be achieved by uncoupling the carrier from the upward guide. This can be done in a number of ways. A first way is to provide an actuator on the carrier whereby the carrier can couple to and uncouple from the upward guide. A second way is described below, wherein the upward guide connected to the rack is formed by a lower segment and wherein an upper segment is not connected to the rack but is connected to the carriage.

The upward guide preferably has an upper and a lower segment. The upper segment is fixedly connected to the carriage and the lower segment is fixedly connected to the rack. This guarantees that the carrier can only move together with the carriage when the carrier is high enough and is held by the upper segment of the guide. When the carrier is situated lower, the carrier is held by a lower segment of the guide which is connected fixedly to the rack. The carrier is thus held by the rack when the carrier is situated at a greater distance from the carriage. Because the carriage only guides the carrier at the top with the upward guide, moments of force on the carriage as a result of the carrier can be only limited because the distance between the carriage and the carrier is limited.

The rail at ground level, which can generally be found in the current systems, limits the utility of the rack, more specifically, makes it impossible for a person to safely move something into and out of the rack, this because the person can do so only by being present in the direct zone of horizontal movement of the pick and place unit. This problem is solved by providing a rail on which a carriage runs at the top. Because it runs at the top of the rack, the carriage is also referred to as the overhead carriage. A carrier is suspended from this carriage.

An additional advantage is related to the choice for the overhead carriage, which makes a rail at ground level unnecessary. When a pick and place unit is placed on the ground, this after all imposes limitations in respect of how the rack can be formed and used. More specifically, owing to the use of an overhead carriage a zone in front of the rack will be safe to enter for a person, even while the overhead carriage is moving. The rack can also be provided with a passage through which persons or even vehicles can pass.

A further advantage is that the assembly of the invention can be constructed on existing racks. This means that a rack which cannot currently be operated automatically can still be provided with automation. It is particularly for smaller racks, i.e. racks with a small height and/or length, that the limited complexity of the assembly of the invention is highly suitable for automation of the rack. For such smaller racks, the investment necessary for a known pick and place unit is often excessively high.

A further advantage is that the assembly of the invention can be constructed irrespective of the stability and straightness of the ground surface. Whereas a traditional pick and place unit rests on the ground surface, typically on a rail, and requires for this purpose a stable and flat ground surface, the assembly of the invention rests on top of the rack. This can be realized considerably more easily on a previously unstable or not very flat ground surface. It is particularly when the rack has been correctly adjusted that the overhead rails which are mounted at the top of the rack are also correctly adjusted.

The carrier is preferably connected to the carriage via flexible connecting means comprising one of cables, straps, ropes and wires. The flexible connecting means preferably form the only direct connection between the carriage and the carrier. By suspending the carrier under the carriage and/or by using cables, straps, ropes or wires for this purpose the stability of the carrier relative to the rack is not provided for by the carriage. In other words, there is only a loose or flexible connection between the carriage and the carrier, whereby the carriage is able to lift the carrier but is unable to fix the carriage. In other words, the carriage is able to control the height position of the carrier or control the distance between the carriage and the carrier, but the carriage has no direct influence on the horizontal absolute position of the carrier. The carrier is suspended from the carriage in the manner of a swing from a swing frame. This would allow the carrier to swing relative to the carriage. The swinging is however prevented in that the carrier engages in the upward guides connected to the carriage during a horizontal movement of the carriage. The upper segments of the upward guides are thereby provided to prevent the swinging of the carrier under the carriage and so fix the horizontal position of the carrier. While the carriage determines the vertical position of the carrier, the upward guide determines the horizontal position. The horizontal position comprises the two directions, on one hand in line with the rack and on the other transversely of the rack. The upward guide determines the horizontal position in both directions.

Each of the plurality of upward guides preferably has a plurality of running surfaces which extend upward and wherein the guide block has at least one contact surface which is provided to strike against the running surfaces in order to substantially block at least one of the first horizontal movement and the second horizontal movement. The upward guide can be formed as a profile with the running surfaces. This can be technically realized in simple manner. The guide block is then provided with contact surfaces which, when the guide block engages on the upward guide, strike against the running surfaces when the carrier tends to move from its predetermined horizontal position.

The contact surface preferably has at least one wheel for rolling over the running surfaces. A wheel allows for simple up and downward movement, wherein the wheel rolls over the running surface while a wheel striking against the running surfaces limits a horizontal movement of the carrier.

The plurality of running surfaces preferably comprise at least four running surfaces which extend upward and each prevent a movement in one horizontal direction in order to together substantially block the first horizontal movement and the second horizontal movement.

The plurality of upward guides are preferably provided on the plurality of columns such that each column has one of the plurality of upward guides. By providing each column of the rack with at least one upward guide the carrier can be moved upward and downward in the column by means of this guide, while the upward guide holds the horizontal position of the carrier.

One upward guide preferably comprises two parts which are provided on either side of the column. By making each upward guide from two parts, these being provided on either side of the column, a balanced whole is obtained, wherein the free space between the carrier and the compartment of the rack is kept open to maximum extent. Forces can also be distributed and/or symmetrically absorbed, which is advantageous.

The upward guides preferably take a discontinuous form so as to substantially block the first horizontal movement and the second horizontal movement, at least when the carrier is positioned at a compartment in the rack. Horizontal forces in particular are exerted on the carrier by manipulation of goods. By providing a discontinuous guide, wherein the horizontal forces are only absorbed when a carrier is positioned at a compartment, the carrier can be guided to sufficient extent.

The carrier preferably comprises a mechanism for pulling goods out of the rack and pushing goods into the rack. When pushing goods into the rack and pulling goods out of the rack a relative force results between the carrier and the rack. More specifically, when goods are pushed into the rack, the carrier will have a tendency to move away from the rack. When pulling goods out of the rack, the carrier will also have a tendency to move toward the rack. In the assembly according to the invention both movements can be absorbed in very simple manner because the carrier is connected via the upward guide to the rack. More specifically, the upward guide, which is connected fixedly to the rack, prevents the carrier from moving away from the rack or toward the rack. Great inward and outward pushing forces can hereby be exerted without additional problems when pushing goods into the rack and pulling goods out of the rack.

The mechanism preferably has a gripper element for engaging on goods, wherein the mechanism has an actuator for displacing the engaged goods into and out of the rack horizontally. The gripping and shifting of goods is considerably simpler than lifting the goods up from the compartment and setting the goods down in the compartment. It will be apparent that goods can be engaged directly or indirectly. Goods can thus be placed on a goods carrier, which goods carrier is compatible with the gripper element so as to be engaged thereby.

The invention further relates to a rack with rows and columns comprising an assembly according to the invention. Each column of the rack is preferably provided here with an upward guide so that the horizontal position of the carrier relative to the column can be maintained during the up and downward movement of the carrier and while goods are taken out of the rack and placed into the rack.

The invention further relates to a method for automating a rack with rows and columns, wherein the method comprises of:
selecting a column and a row related to a position in the rack;
moving a carriage horizontally to a predetermined position, related to the selected column, over a lying rail which is provided at the top of the rack;
moving a carrier, which is connected to the carriage, downward along an upward guide in order to position the carrier in a predetermined manner relative to the selected row;
performing a predetermined action with the carrier;
   wherein performing the predetermined action is one of pushing goods into the rack and pulling goods out of the rack while the horizontal position of the carrier is maintained in that a guide block of the carrier engages in the upward guide.

During the downward movement of the carrier, wheels of the guide block preferably roll against running surfaces of the upward guide.

Advantages and effects described above with reference to the assembly similarly apply to the method.

According to a further embodiment, the invention provides an assembly for automating a rack with rows and columns, wherein the assembly has a lying rail which is provided for placing at the top of the rack so that the lying rail extends over a plurality of columns, wherein the assembly further comprises a carriage which is compatible with the lying rail so as to be movable along the plurality of columns, wherein the system further comprises a carrier which is connected movably to the carriage so it is moveable up and downward along a plurality of rows, wherein the assembly further has an upward guide for guiding the carrier during the up and downward movement, wherein the upward guide comprises an upper segment which is connected fixedly to the carriage and comprises a plurality of lower segments which are provided to be fixedly connected to the rack.

A stand-alone pick and place unit is expensive because stability while moving goods into and out of the rack and during horizontal displacement of the unit is difficult to realize. A stand-alone pick and place unit is traditionally supported by a rail at ground level, over which the pick and place unit travels. It is particularly when a heavy object is taken from the rack that the pick and place unit will have a tendency to tilt sideways, and reinforcements must be arranged for this purpose. A further guide rail, whereby the lateral vertical stability transversely of the longitudinal movement is achieved, is for this purpose typically provided on the upper side. Since such a pick and place unit has vertically at least the height of the rack, precautions must likewise be taken so that the tendency to tilt is compensated for during acceleration and deceleration of the high unit with loads. The rail at ground level, which can generally be found in the current systems, limits the utility of the rack, more specifically, makes it impossible for a person to safely move something into and out of the rack, this because the person can do so only by being present in the direct zone of horizontal movement of the pick and place unit. Multiple expensive modifications must be made in order to ensure the safety of a stand-alone pick and place unit.

The invention is based on the insight that when a pick and place unit is integrated with a rack, using a so-called overhead carriage, many of the drawbacks stated above in the context of a stand-alone pick and place unit will be obviated without any major additional modifications. This makes the assembly according to the invention considerably cheaper and simpler than existing pick and place units. According to the invention, the rack is provided at the top with a rail on which a carriage runs. Because it runs at the top of the rack, this carriage is also referred to as the overhead carriage. Attached to this carriage is a carrier, which carrier will move the goods into and out of the rack and which carrier will transport the goods between a first and a second position. When moving up and downward the carrier is guided by an upward guide. The upward guide has an upper and a lower segment. The upper segment is fixedly connected to the carriage and the lower segment is fixedly connected to the rack. This guarantees that the carrier can only move together with the carriage when the carrier is high enough and is held by the upper segment of the guide. When the carrier is situated lower, the carrier is held by a lower segment of the guide which is connected fixedly to the rack. The carrier is thus held by the rack when the carrier is situated at a greater distance from the carriage. This provides advantages in respect of stability, and thereby also advantages in respect of safety. Because the carriage only guides the carrier at the top with the upward guide, moments of force on the carriage as a result of the carrier can be only limited because the distance between the carriage and the carrier is limited.

An additional advantage is related to the choice for the overhead carriage, which makes a rail at ground level unnecessary. When a pick and place unit is placed on the ground, this after all imposes limitations in respect of how the rack can be formed and used. More specifically, owing to the use of an overhead carriage a zone in front of the rack will be safe to enter for a person, even while the overhead carriage is moving. The rack can also be provided with a passage through which persons or even vehicles can pass.

A further advantage is that the assembly of the invention can be constructed on existing racks. This means that a rack which cannot currently be operated automatically can still be provided with automation. It is particularly for smaller racks, i.e. racks with a small height and/or length, that the limited complexity of the assembly of the invention is highly suitable for automation of the rack. For such smaller racks, the investment necessary for a known pick and place unit is often excessively high.

A further advantage is that the assembly of the invention can be constructed irrespective of the stability and straightness of the ground surface. Whereas a traditional pick and place unit rests on the ground surface, typically on a rail, and requires for this purpose a stable and flat ground surface, the assembly of the invention rests on top of the rack. This can be realized considerably more easily on a previously unstable or not very flat ground surface. It is particularly when the rack has been correctly adjusted that the overhead rails which are mounted at the top of the rack are also correctly adjusted.

The plurality of lower segments of the upward guide are preferably related to the plurality of columns. The rack is constructed from a plurality of rows and a plurality of columns. The rack thereby provides a substantially two-dimensional grid, wherein goods are placeable in each compartment of the grid. The carrier is situated adjacently of the rack, i.e. in a space lying adjacently of the two-dimensional grid, wherein the carrier is able to position itself at each compartment in the grid by a combination of horizontal and vertical displacements. The lower segments of the upward guides are connected fixedly to the rack, typically at the position of the space where the carrier is situated.

The upward guides preferably take a discontinuous form so as to substantially block the first horizontal movement and the second horizontal movement, at least when the carrier is positioned at a compartment in the rack. Horizontal forces in particular are exerted on the carrier by manipulation of goods. By providing a discontinuous guide, wherein the horizontal forces are only absorbed when a carrier is positioned at a compartment, the carrier can be guided to sufficient extent.

The assembly preferably has a sensor for detecting an alignment of the upper segment and one of the plurality of lower segments of the upward guide. When the upper and one of the lower segments of the upward guide are aligned, these two segments functionally form one guide along which the carrier can move upward and downward in a vertical direction. It is noted here that the form and the type of the upper segment and the lower segment of the guide need not necessarily be the same. They may be the same, for instance profile-like with a predetermined profile cross-section, wherein, owing to the alignment, the profile segments together form one substantially continuous profile over which the carrier can move. Alternatively, the carrier has on the side of the carriage first guides which determine the relative horizontal position of the carrier relative to the carriage when this first guide engages in the upper segment, and the carrier has on the side of the rack second guides which determine the relative horizontal position of the carrier relative to the rack when this second guide engages in the lower segment. These guides and upper and lower segments can be different.

The assembly preferably comprises a first drive for moving the carriage automatically along the lying rail and a second drive for moving the carrier automatically relative to the carriage. Owing to the first and second drive, the carrier can be positioned relative to a predetermined compartment of the rack.

The carrier is preferably connected to the carriage via one of cables, straps, ropes and wires. The carrier is preferably suspended under the carriage. By suspending the carrier under the carriage and/or by using cables, straps, ropes or wires for this purpose the stability of the carrier relative to the rack is not provided for by the carriage. In other words, there is only a loose or flexible connection between the carriage and the carrier, whereby the carriage is able to lift the carrier but is unable to fix the carriage. In other words, the carriage is able to control the height position of the carrier or control the distance between the carriage and the carrier, but the carriage has no direct influence on the horizontal absolute position of the carrier. The carrier is suspended from the carriage in the manner of a swing from a swing frame. This allows the carrier to swing relative to the carriage. The swinging is however prevented in that the carrier engages in the upward guides connected to the carriage during a horizontal movement of the carriage. The upper segments of the upward guides are thereby provided to prevent the swinging of the carrier under the carriage and so fix the horizontal position of the carrier. While the carriage determines the vertical position of the carrier, the upward guide determines the horizontal position. The horizontal position comprises the two directions, on one hand in line with the rack and on the other transversely of the rack. The upward guide determines the horizontal position in both directions.

The carrier preferably has a guide block which is compatible with the upward guide. The guide block can comprise sliding surfaces and/or wheels for determining the horizontal position of the carrier.

The invention further relates to a rack with rows and columns comprising an assembly according to the further embodiment. Each column preferably comprises a lower segment of the upward guide which extends to a predetermined height, and the carriage with the upper segment of the guide is preferably situated above the predetermined height.

The invention further relates to a method for automating a rack with rows and columns, wherein the method comprises of:
selecting a column and a row;
moving a carriage horizontally to a predetermined position, related to the selected column, over a lying rail which is provided at the top of the rack;
moving a carrier, which is connected to the carriage, vertically downward along an upward guide in order to position the carrier in a predetermined manner relative to the selected row;
performing a predetermined action;
moving the carrier vertically upward to a predetermined height before moving the carriage from the predetermined position.

Advantages and effects described above with reference to the assembly similarly apply to the method.

During the downward movement and upward movement the carrier preferably moves along an upward guide with at least two segments, an upper segment which is fixedly connected to the carriage and one of a plurality of lower segments which are fixedly connected to the rack. The horizontal movement is preferably preceded by a check whether the carrier is situated at the position of the upper segment of the upward guide. The method preferably further comprises, prior to the vertical downward movement, of a check whether the upper segment of the upward guide is aligned with one of the plurality of lower segments of the upward guide.

The invention will now be further described on the basis of exemplary embodiments shown in the drawings.

In the drawing:

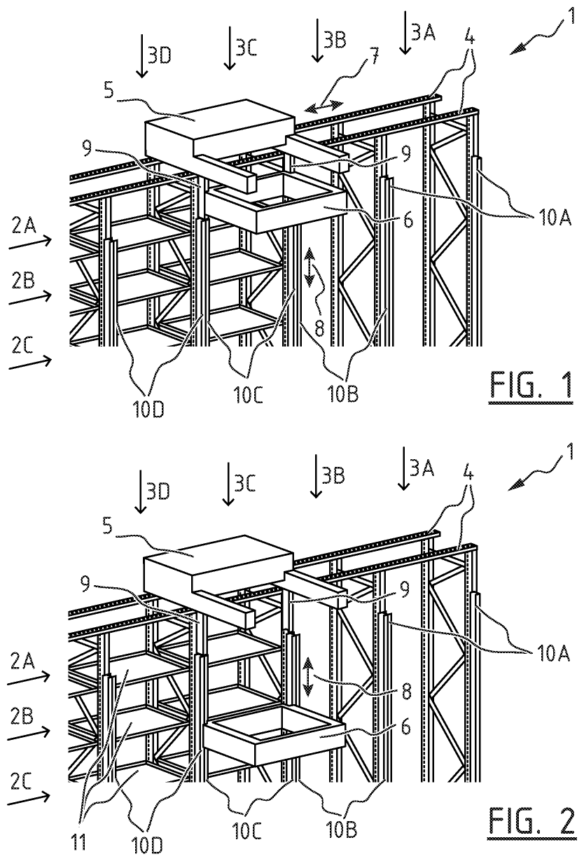

FIG. 1 shows a schematic structure in a first state of an assembly according to a preferred embodiment of the invention;

FIG. 2 shows a schematic structure in a second state of the assembly of FIG. 1;

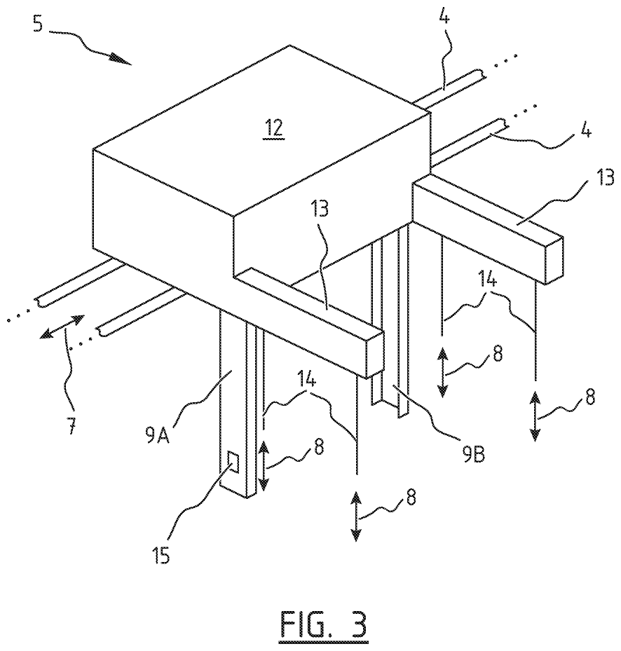

FIG. 3 shows a detail of a carriage usable in the assembly according to an embodiment of the invention;

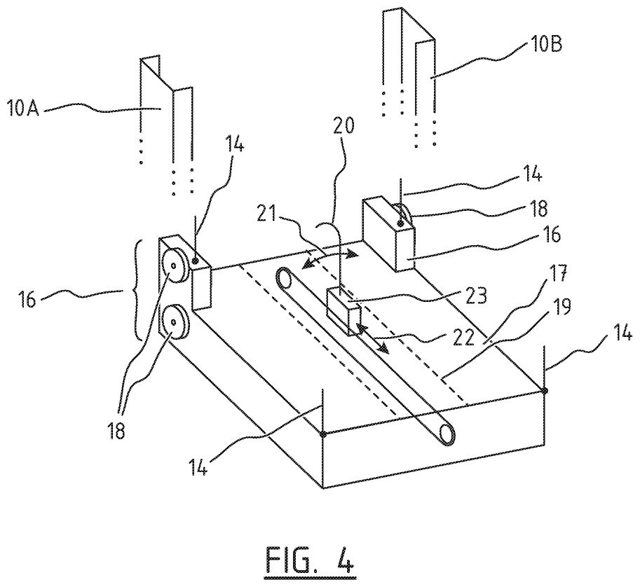

FIG. 4 shows a detail of a carrier usable in the assembly according to an embodiment of the invention;

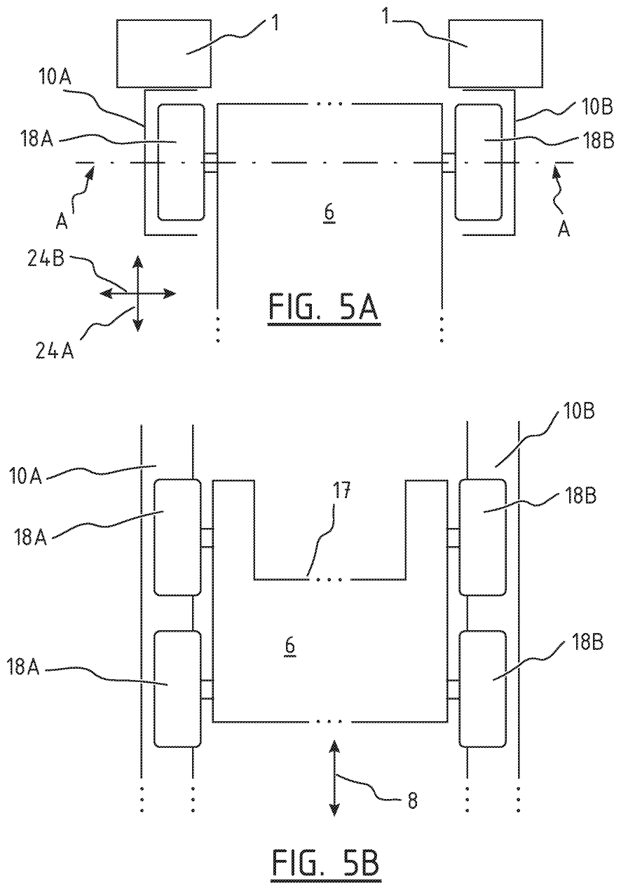

FIGS. 5A and 5B show several cross-sections of the carrier of FIG. 4 at the position of the guide block;

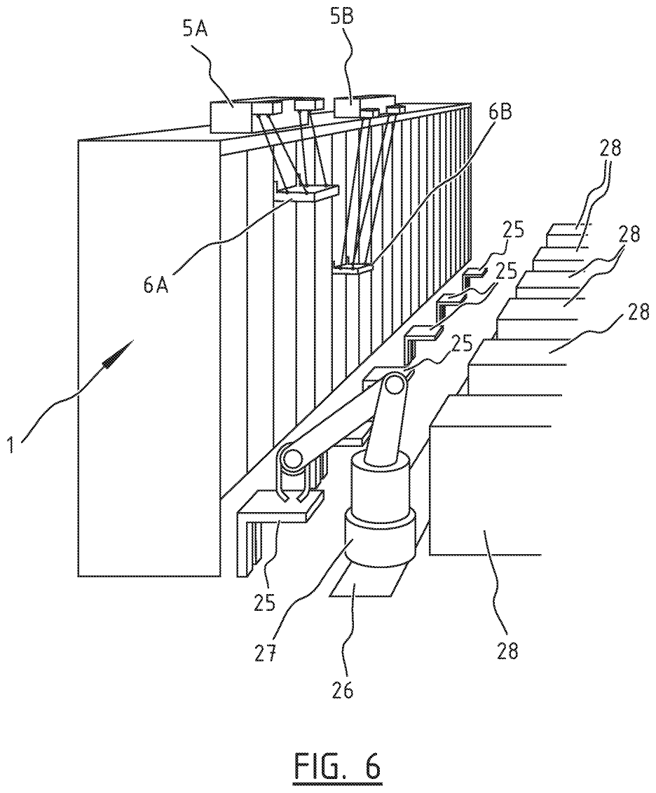

FIG. 6 shows the assembly according to a further preferred embodiment of the invention in an actual application;

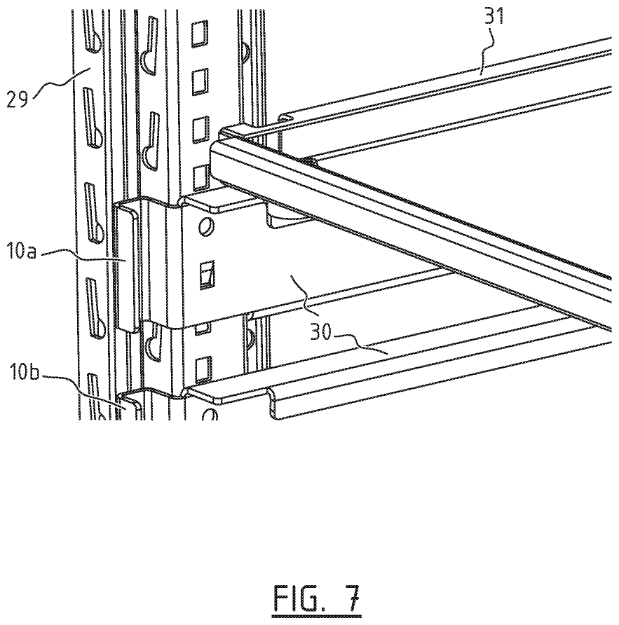

FIG. 7 shows a detail of an embodiment of an upward guide; and

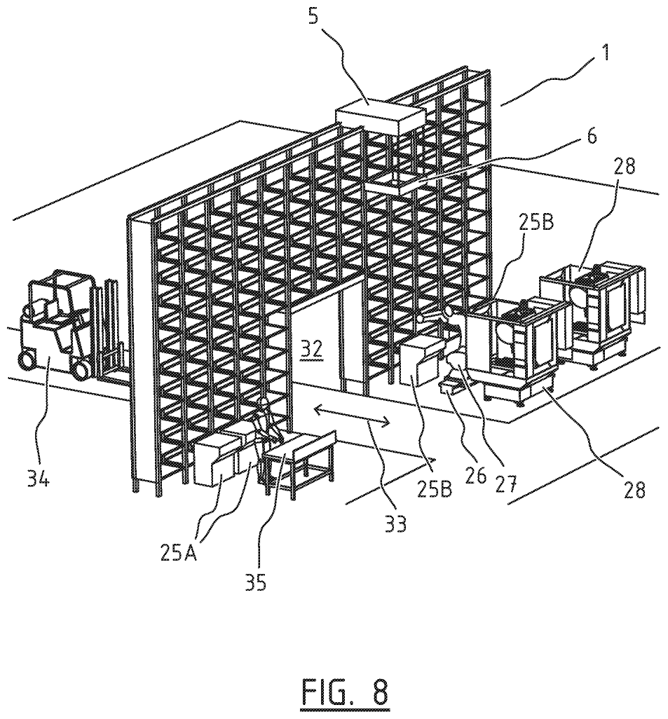

FIG. 8 shows the assembly according to a further preferred embodiment of the invention in an actual application.

The same or similar elements are designated in the drawings with the same reference numerals. The assembly preferably has a sensor for detecting an alignment of the upper segment and one of the plurality of lower segments of the upward guide. When the upper and one of the lower segments of the upward guide are aligned, these two segments functionally form one guide along which the carrier can move upward and downward in a vertical direction. It is noted here that the form and the type of the upper segment and the lower segment of the guide need not necessarily be the same. They may be the same, for instance profile-like with a predetermined profile cross-section, wherein, owing to the alignment, the profile segments together form one substantially continuous profile over which the carrier can move. Alternatively, the carrier has on the side of the carriage first guides which determine the relative horizontal position of the carrier relative to the carriage when this first guide engages in the upper segment, and the carrier has on the side of the rack second guides which determine the relative horizontal position of the carrier relative to the rack when this second guide engages in the lower segment. These guides and upper and lower segments can be different.

The assembly preferably comprises a first drive for moving the carriage automatically along the lying rail and a second drive for moving the carrier automatically relative to the carriage. Owing to the first and second drive, the carrier can be positioned relative to a predetermined compartment of the rack.

FIG. 1 shows a rack 1. A rack is typically used for storing goods. For this purpose the rack is typically provided with a frame structure with compartments. The compartments are arranged in a plurality of rows 2 and columns 3. Although most racks have a repetitive configuration, it is not necessary for a rack to take a repetitive form. A different number of rows can be provided for each column 3, and the number of rows and/or the relative size of the different rows need not necessarily be the same for adjacent columns. The shown embodiments are based on a rack 1 in which at least the columns 3 have a substantially constant width. The figures show a rack with a constant width, which forms the depth of the compartment. The rack can also have different widths at different positions. The system described below is further provided to place goods in the compartment at a fixed depth, or can be provided to place goods in the compartment at different depths, for instance to place a plurality of units of a good in one compartment.

The rack 1 is provided at the top with a rail 4. The rail 4 typically and preferably extends over substantially the whole length of rack 1. The lying rail 4 thereby extends over a plurality of columns 3. The term lying refers to the direction of the rail 4, which is substantially horizontal. The lying rail 4 can be suspended in the substantially horizontal direction at the position of the upper side of the rack 1, and will still be a lying rail 4. The lying rail 4 is shown as a double rail in FIG. 1. The skilled person will appreciate that the rail bracket can be provided in a single or multiple number. The lying rail 4 is provided to have a carriage 5 move thereover. For this purpose the carriage 5 is compatible with the lying rail 4. The carriage 5 can move over the lying rail in the longitudinal direction of rack 1. Carriage 5 can hereby position itself in multiple positions which are each related to a column 3 of rack 1. When goods are moved into or out of the rack, a compartment of the rack 1 is typically selected. This selected compartment is typically characterized by a predetermined column, for instance 3C, and a predetermined row, for instance 2B. This combination of a selected row and selected column is related to a compartment in the rack. The carriage can then position itself in a position which is related to the selected column. In FIG. 1 the carriage 5 is in the position which is related to column 3C.

FIG. 1 shows schematically a carrier 6. The carrier 6 is provided to carry goods. The carrier 6 will be described in more detail below. The carriage 5 is provided to move in the longitudinal direction 7 of rack 1. Carrier 6 is provided to move in the height direction 8 of rack 1. The carriage is thereby provided to move over a plurality of columns and the carrier 6 is provided to move over a plurality of rows 2. Owing to a combination of the movement of carriage 5 and carrier 6, the carrier can be placed close to substantially any compartment in rack 1. This allows goods to be placed into and/or removed from random compartments of rack 1 via the carrier.

Carrier 6 is suspended on one side from carriage 5, preferably via flexible connecting means. Examples of flexible connecting means are cables, straps, wires, cords and so on. The distance between carriage 5 and carrier 6 can be controlled via the flexible connecting means, whereby the height position of carrier 6 is determined. Carrier 6 is further provided with a guide block, further described below, which engages on upward guides 10. The upward guides 10 are provided in a number which is related to the number of columns 3 in the rack. More specifically, each column 3 is provided with an upward guide 10. When a carrier 6 moves upward and/or downward, the guide block engages on one of the upward guides 10. The position of carrier 6 in the horizontal plane will be determined thereby. This will be further elucidated below. During the upward and downward movement, carrier 6 will therefore always move relative to a selected column 3.

In the embodiment of FIG. 1 the upward guides 10 extend to a predetermined height. This predetermined height is lower than the overall height of rack 1. The upward guide 10 will hereby only be able to guide carrier 6 over a limited height range. More specifically, the upward guide 10 can guide the carrier 6 in a lower part of its movement, this being the movement of carrier 6 between a lower extreme position and the predetermined height. When the carrier reaches above the predetermined height, carrier 6 is no longer held by the upward guide 10. In order to control the position of the carrier above the predetermined height, carriage 5 is provided with a guide 9. In the shown embodiment guide 9 is similar to the upward guide 10. When it is aligned with an upward guide 10, the guide 9 of carriage 5 thereby forms an extension for this upward guide so that the combination of the guide and the upward guide ensures that the carrier is held over the whole height, this being all the way up to the upper side of rack 1. In other words, the upward guide comprises two parts or two segments. A lower segment is connected fixedly to the rack and designated in FIG. 1 with reference numeral 10. An upper segment is designated in FIG. 1 with reference numeral 9 and is connected fixedly to the carriage 5. A plurality of lower segments 10 are provided, each related to a column 3. Only one upper segment is provided, this being related to the carriage 5. When a plurality of carriages are placed on the rail 4, a plurality of upper segments 9 will of course also be provided.

The lower segments 10 of the upward guide are connected fixedly to the rack. This is understood to mean that the lower segments 10 are not movable relative to the rack, not even when the carriage and/or the carrier moves. The lower segments 10 are preferably connected fixedly to the rack, i.e. connected fixedly to the frame structure forming the rack, at two and more preferably at more than two different height positions. In an embodiment the lower segments 10 of the upward guide are integrated in and thereby connected permanently to the frame structure of the rack.

In FIG. 1 the carrier 6 is shown at the position of an upper segment 9 of the upward guide. When the carrier is situated at this height, it is possible for carriage 5 to perform a horizontal movement. This is because, when carriage 5 moves over rail 4, the upper segment of guide 9, which holds carrier 6, will co-displace. Carriage 5 can hereby be moved with carrier 6 to a predetermined position, related to a selected column.

FIG. 2 shows a rack 1 with a carriage 5 and a carrier 6 which corresponds to FIG. 1, as described above. In FIG. 2 carrier 6 is shown at a height lying below the predetermined height. This means that the carrier is being held by the lower segment 10 of the upward guide. When carrier 6 is situated at such a height, carriage 5 is preferably held still in a horizontal plane. A horizontal movement of the carriage would not result in a corresponding horizontal movement of the carrier, this because the carrier is being held by the upward guide 10 which is connected fixedly to the rack. Within the column 3 where carrier 6 is situated the carrier can be moved upward and downward in order to position itself close to a selected row. In this position the carrier can move goods into and out of the relevant compartment of rack 1. In FIG. 2 compartments in the rack are designated with reference numeral 11.

FIG. 3 shows a carriage 5 according to an embodiment of the invention. The carriage has a base body 12. The base body typically comprises a housing inside which one or more actuators are provided. A first actuator is for instance a motor for moving the carriage over rail 4, wherein the movement in FIG. 3 is designated with arrow 7. Carriage 5 can further be provided with an actuator for controlling the height of carrier 6. Movement of the carrier is indicated in FIG. 3 with arrows 8. The carrier is preferably suspended from carriage 5. For this purpose the carriage 5 has carrier arms 13 which extend from the base body 12 to a position at least partially above carrier 6. Provided from the carrier arms 13 are flexible connecting means 14 for suspending the carrier 6. Flexible connecting means are shown as cables in FIG. 3. A roll with a plurality of segments for winding up and unwinding the cables 14, in order to thus control the height of carrier 6, can be provided in base body 12. The motor for driving the roll is preferably also provided in base body 12.

FIG. 3 further shows that the upper segments of the upward guides 9 extend downward from base body 12. This is just one embodiment. In this embodiment the upward guide 9 takes the same form as the upward guide 10 which is connected to the rack. The upward guide 9 thereby forms an extension of the upward guide 10 when the carriage is placed above a selected column. The upper guide can alternatively be embodied differently than the guide between the upward guide 10 connected to rack 1 and the carrier 6. The carrier can for instance have two upward pins which fit into openings in the carrier arms. The above stated predetermined height, the length of the pins and the openings in carrier arm 13 are then preferably chosen such that, when the carrier reaches above the predetermined height, the pins on the carrier engage in the openings of carrier arm 13 such that the horizontal position of carrier 6 relative to the carriage is fixed. In this alternative embodiment the pins and the openings are deemed upper segments of the upward guide, while the lower segment of the upward guide is formed by the profile which is connected to the rack. Functionally, the guiding is transferred from the upward guide 10 to the pins and holes, while visually, the upward guide does not continue.

An advantage of the construction as shown in FIG. 3 is that a sensor 15 which can verify the relative position of the upper segment and the lower segment of the upward guide 9 and 10 can be placed in simple manner. By providing the sensor 15 the carriage can be controlled in an inexpensive manner. The guide of the carriage need not know the exact position of the carriage. The correct position is indicated by sensor 15. Carriage 5 can here be provided to act in the following way. The carriage 5 moves together with carrier 6 in a horizontal direction to a preselected column 3. When the carriage is roughly in the desired position, the sensor 15 will determine the final position of the carriage. When the sensor detects that the upper guide is aligned with the lower segment of guide 10, the carrier 8 may be lowered. Carriage 5 then remains in position until the carrier returns to a position above the predetermined height. In its simplest embodiment, the sensor 15 can also be a switch which can be pressed, this will be deemed a contact sensor.

FIG. 4 shows a detailed perspective view of an embodiment of a carrier 6. The carrier 6 is suspended from the carriage 5 (not shown in FIG. 4) via the flexible connection 14. Via the flexible connection 14 the height of carrier 6 is thereby determined, and the carrier 6 can be moved upward and downward. Carrier 6 has a guide block 16 and a carrying surface 17. In the shown embodiment guide block 16 is embodied in two parts, a left-hand part and a right-hand part. The carrier engages with guide block 16 in the upward guides 10 which are connected to rack 1. The carrier 17 is provided to carry goods.

In the shown embodiment the guide block 16 comprises four wheels 18, two on each part of the guide block 16. The wheels serve to hold the guide block in a predetermined horizontal position while the upward and downward movement of carrier 6 is not impeded, or only to minimal extent. Wheels 18 are formed and placed such that they strike against running surfaces of the upward guide 10 when the carrier attempts to move outside a predetermined horizontal position. In the embodiment shown in FIG. 4 two wheels are placed one above the other on either side of the guide block 16. By providing two wheels at a distance from each other, these lying mutually in line, it is possible not only to hold in horizontal position but also to prevent a rotation or tilting of the carrier. More specifically, the construction as shown in FIG. 4 makes it possible to prevent a rotation about an upward axis because wheels are provided on either side of carrier 6, and a rotation about a horizontal axis can further be prevented both transversely of the direction of the rack and parallel to the direction of the rack in that two wheels are provided one above the other. The wheels are provided to be placed at least partially in the upward guide which is U-shaped. The wheels are thereby provided to strike against the legs of the U-shaped upward guide. The outer sides of the wheels are then provided to strike against the base of the U-shaped upward guide. The carrier is thereby held at a position transversely of the rack by the running surfaces of the wheels, and the carrier is held at a position parallel to the rack by the sides of the wheels.

The carrying surface 17 is provided to carry goods. The carrying surface 17 preferably further comprises a mechanism 19 for pushing goods into the rack and pulling goods out of the rack. In the shown embodiment the carrying surface is provided with a look 20 which can grip goods with a movement, the movement being shown with arrow 21 in FIG. 4. The hook 20 is provided on a hook block 23 which can perform a horizontal movement 22 in a direction transversely of the rack. This allows the hook block 23 to be moved toward goods, after which the hook 20 engages in order to take hold of the goods. Following this, the hook block 23 with the hook 20 can be moved away from the rack and so pull the goods from the rack and onto the carrier 17. Pushing goods back into the rack can be done in similar manner by pushing the goods toward the rack and then releasing the hook 20. In a preferred embodiment goods can also be pushed in the other direction of carrier 17, for instance by moving the hook under the goods and to the rack side of the goods, after which the hook can be moved upward and pushes the goods off the carrying surface 17 by a movement away from the rack. The skilled person will appreciate that the shown and described embodiment with the hook is just one of the many options for engaging goods in order to pull them from the rack and push them back into the rack. The invention is not limited to the shown and described embodiment.

FIGS. 5A and 5B show different cross-sections of the carrier at the position of the guide blocks 16 in order to provide insight into the operation of the guide blocks and the wheels 18. FIG. 5A shows a horizontal cross-section and shows that wheels 18A and 18B engage in respective upward guides 10A and 10B. The wheels prevent a movement of the carrier away from rack 1 and toward the rack in that the wheels will then strike or press with their running surface against the legs of the U-shaped upward guides 10. The movement away from the rack and toward the rack is indicated with arrow 24A. The wheels also prevent a movement of carrier 6 in a direction parallel to the rack, indicated with arrow 24B, since the wheels 18A and 18B will then strike with their outer sides against the upward guides 10A and 10B. The horizontal position 24 of carrier 6 is hereby determined by the upward guides and the guide blocks. The skilled person will appreciate that the shown construction with two opposite U-shaped profiles is only one exemplary embodiment, and that the upward guide and guide blocks can take different forms. When the upward guide and/or the guide blocks have a more complex form, it is possible to provide only one upward guide per column. Carrier 6 will then be constructed asymmetrically so that it can be guided in the upward and downward direction via this one upward guide, wherein the horizontal position of the carrier is maintained by the upward guide. The invention is therefore not limited to the shown and described embodiment. FIG. 5B shows the cross-section A-A, see FIG. 5A, and shows that two wheels 18A and 18B are provided on either side of carrier 6. The wheels allow the carrier to make an up and downward movement 8.

FIG. 6 shows an embodiment of a rack 1 which is provided with a system for automating the rack as described above. More specifically, the rack 1 comprises a plurality of carriages 5A and 5B which are each connected to a carrier 6A, 6B. In the shown embodiment the rack is placed close to a plurality of working machines 28. Working machines 28 are for instance lathes, CNC machines, drills, 3D printers or other machines for manufacturing and/or machining workpieces. Loading and unloading of the working machines with workpieces is preferably done automatically. The exchanging of tools preferably also takes place automatically. In the shown embodiment a robot arm 27 is for this purpose placed on a rail 26 which is positioned between the working machines 28 and the rack 1. In the shown embodiment the rack 1 has a plurality of set-down stations 25. A set-down station 25 is a platform which is provided in a lower zone of a column 3 of the rack 1, adjacently of the rack, and which a carrier 6 can set goods down on and take goods up from. By providing one or more set-down stations 25 a rack 1 can be automated with the above described system such that predetermined goods, for instance workpieces and/or tools, are removed from the rack 1 and placed on the set-down station 25. The robot arm 27 can take the workpieces and/or tools on the set-down station 25 and carry them to the working machine 28. When workpieces are finished, workpieces can also be set down on set-down stations 25, where carrier 6 can take up the finished workpieces and displace them to the rack 1 or to another set-down station 25.

It will be apparent that FIG. 6 shows only one specific application of the system for automating the rack. In an alternative embodiment the set-down stations are provided close to workstations, for instance assembly areas, so that an operator of the workstation is provided with tools and/or workpieces from the rack and can transport tools and/or workpieces to the rack.

As further alternative, the set-down station is formed or coupled with automatic vehicles, also referred to as AGV (automated guided vehicle). These automatic vehicles can displace the workpieces and/or tools further. The rack as described above his highly suitable to be provided with AGVs and/or close to workstations. This is because the rack is controlled wholly from above. This means that the primary movements of the carriage and the carrier will take place high up in the rack. This allows the rack to be provided with one or more passages for persons and/or for AGVs without an immediate risk of collision between the carriage with carrier on one side and the person or AGV on the other.

Each described assembly preferably has at least one set-down station 25, preferably at least two set-down stations 25. As described at length above, the above described construction of the assembly is particularly advantageous because a horizontal movement of the carriages and the carrier 6 takes place only when carrier 6 is situated, together with the carriage, at the top of the rack 1. A person or a robot arm 27 can hereby safely take up workpieces from the set-down station and safely place pieces on a set-down station 25 without this resulting in a risk of collision. Set-down stations 25, rail 26 of robot arm 27 and the robot arm 27 are not in the way of the system whereby rack 1 is automated either. All this is highly advantageous.

The carriages 5 shown in the figures have arms which extend to only one side of the rack. It is however possible to have arms extend on and to provide a carrier on two sides of the rack. A rack can thus be automated along two sides. It is further possible to place a plurality of racks parallel to each other, wherein carriages are formed in the manner of a bridge over the racks and wherein the carrier is situated between the racks and is able to handle goods from both racks. The operating principles in such embodiments are similar to the above described operating principles, wherein the skilled person will appreciate that a determined variation becomes possible, particularly in forming of the upward guides 10 which are connected to the rack 1.

FIG. 7 shows an embodiment wherein a frame structure 29 of a rack is provided with lying frame elements 30 which also comprise the lower segments 10 of the upward guide. In FIG. 7 these lower segments 10 are not continuous, and are designated with 10a and 10b. When the carrier is situated at the position of the relevant compartment, formed by the lying frame element 30, the carrier will engage with its guide block in the upward guides 10a or 10b so that the horizontal position is ensured. FIG. 7 further shows a goods carrier 31 on which goods can be placed and which goods carrier 31 can be slid into and out of the rack by the carrier. It will be apparent that goods can be engaged directly or indirectly. Goods can thus be placed on a goods carrier, which goods carrier is compatible with the gripper element so as to be engaged thereby.

FIG. 8 shows a further embodiment wherein a rack 1 is shown in a different situation of use. The rack 1 has on one side, similarly to FIG. 6, set-down stations 25B. These set-down stations 25B allow a carriage 5 and carrier 6 to place goods from the rack 1 onto the set-down station 25B and to take up goods from the set-down station 25B and place them in the rack 1. The set-down stations 25B are positioned close to a rail 26 with robot 27 which can load and unload machines 28. Rack 1 further has set-down stations 25A. These set-down stations 25A also allow a carriage 5 and carrier 6 to place goods from the rack 1 onto the set-down station 25A and to take up goods from the set-down station 25A and place them in the rack 1. In contrast to set-down stations 25B, set-down stations 25A are not provided close to a robot but are provided close to a worktable 35 where an operator can manually process and/or check goods. This figure thereby illustrates the versatility in use of the rack 1 according to the invention. It will be apparent here that set-down stations can also serve other purposes, for instance delivering and/or taking up goods from automatic vehicles, wherein a platform of the automatic vehicle forms the set-down station, at least when the vehicle is positioned at a predetermined position. As further alternative, the set-down station serves to deliver and/or take up goods from a conveyor belt, wherein the set-down station can be formed by a start and/or end of the conveyor belt.

FIG. 8 shows a further aspect of the rack 1 according to the invention, this being that the rack can have passages 32. The passage 32 allows for an opening over a predetermined width and a predetermined height from the ground surface, through which persons and/or vehicles can pass. This is indicated with arrow 33. In FIG. 8 the passage 32 is formed such that a forklift truck 34 fits through the passage 32.

The skilled person will appreciate on the basis of the above description that the invention can be embodied in different ways and on the basis of different principles. The invention is not limited here to the above described embodiments. The above described embodiments and the figures are purely illustrative and serve only to increase understanding of the invention. The invention is not therefore limited to the embodiments described herein, but is defined in the claims.

1. Assembly for automating a rack with rows and columns, wherein the assembly has a lying rail which extends over a plurality of columns, wherein the assembly further comprises a carriage which is compatible with the lying rail so as to be movable along the plurality of columns, wherein the system further comprises a carrier which is connected movably to the carriage for up and downward movement along a plurality of rows, wherein the assembly further has a plurality of upward guides for guiding the carrier during the up and downward movement, wherein the plurality of upward guides are provided to be fixedly connected to the rack, wherein the carrier has a guide block which is compatible with the upward guides in a manner such that a first horizontal movement of the carrier in line with the rack and a second horizontal movement of the carrier transversely of the rack is substantially prevented while an upward and downward movement of the carrier is allowed.

2. Assembly according to claim 1, wherein the carrier is connected to the carriage via flexible connecting means comprising one of cables, straps, ropes and wires.

3. Assembly according to claim 2, wherein the flexible connecting means form the only direct connection between the carriage and the carrier.

4. Assembly according to claim 1, wherein the carrier is suspended under the carriage.

5. Assembly according to claim 1, wherein each of the plurality of upward guides has a plurality of running surfaces which extend upward and wherein the guide block has at least one contact surface which is provided to strike against the running surfaces in order to substantially block at least one of the first horizontal movement and the second horizontal movement.

6. Assembly according to claim 5, wherein the contact surface has at least one wheel for rolling over the running surfaces.

7. Assembly according to claim 6, wherein the plurality of running surfaces comprise at least four running surfaces which extend upward and each prevent a movement in one horizontal direction in order to together substantially block the first horizontal movement and the second horizontal movement.

8. Assembly according to claim 1, wherein the plurality of upward guides are provided on the plurality of columns such that each column has one of the plurality of upward guides.

9. Assembly according to claim 8, wherein one upward guide comprises at least two parts which are provided on either side of the column.

10. Assembly according to claim 9, wherein the upward guides take a discontinuous form so as to substantially block the first horizontal movement and the second horizontal movement, at least when the carrier is positioned at a compartment in the rack.

11. Assembly according to claim 1, wherein the carrier comprises a mechanism for pulling goods out of the rack and pushing goods into the rack.

12. Assembly according to claim 11, wherein the mechanism has a gripper element for engaging on goods and wherein the mechanism has an actuator for displacing the engaged goods into and out of the rack horizontally.

13. Rack with rows and columns comprising an assembly according to claim 1.

14. Method for automating a rack with rows and columns, wherein the method comprises of: selecting a column and a row related to a position in the rack; moving a carriage horizontally to a predetermined position, related to the selected column, over a lying rail which is provided at the top of the rack; moving a carrier, which is connected to the carriage, downward along an upward guide in order to position the carrier in a predetermined manner relative to the selected row; performing a predetermined action with the carrier; wherein performing the predetermined action is one of pushing goods into the rack and pulling goods out of the rack while the horizontal position of the carrier is maintained in that a guide block of the carrier engages in the upward guide.

15. Method according to claim 14, wherein, during the downward movement of the carrier, wheels of the guide block roll against running surfaces of the upward guide.
